(19) United States
(12) Patent Application Publication
(10) Pub. No.: US 2010/0199689 A1
(43) Pub. Date: Aug. 12, 2010

(54) CRYOSTAT OF SUPERCONDUCTING CABLE

(76) Inventors: Chang-Youl Choi, Gumi-si (KR); Su-Kil Lee, Gumi-si (KR); Choon-Dong Kim, Gunpo-si (KR); Hyun-Man Jang, Hwaseong-si (KR); Bong-Ki Ji, Yongin-si (KR)

Correspondence Address: SHERR & VAUGHN, PLLC, 620 HERNDON PARKWAY, SUITE 320, HERNDON, VA, 20170, US

(21) Appl. No.: 12/500,384

(22) Filed: Jul. 9, 2009

(30) Foreign Application Priority Data
Feb. 12, 2009 (KR) 10-2009-0011308

(51) Int. Cl. F17C 3/04; F17C 3/08

(52) U.S. Cl. 62/51.1

(57) ABSTRACT

A cryostat of a superconducting cable disclosed herein includes an inner metallic tube filled with liquid nitrogen and extended along the circumference of a core, an outer metallic tube surrounding the circumference of the inner metallic tube at a distance, a cooling vessel of a terminal connecting box connected to the inner metallic tube and filled with liquid nitrogen, an insulation tube surrounding the circumference of the cooling vessel at a distance, an inner bellows tube connecting an end of the outer metallic tube to the cooling vessel, and an outer bellows tube spaced apart from the inner bellows tube and connecting the end of the outer metallic tube to the insulation tube.

### CROSS-REFERENCE TO RELATED APPLICATION

This application claims priority to Korean Patent Application No. 10-2009-0011308, filed on Feb. 12, 2009, and all the benefits accruing therefrom under 35 U.S.C. §119, the contents of which in its entirety are herein incorporated by reference.

### BACKGROUND

1. Field

This disclosure relates to a cryostat of a superconducting cable, and specifically to a cryostat of a superconducting cable absorbing stress occurring due to the difference in the thermal shrinkage rates of an inner and outer metallic tubes, and separating vacuum layers.

2. Description of the Related Art

Superconductivity is a phenomenon characterized by zero electrical resistance in certain materials at very low temperatures, and a superconducting cable is a power cable manufactured to embody such a characteristic. Liquid nitrogen may be used to realize the phenomenon, and the conductor bears superconductivity owing to the low temperature provided by liquid nitrogen.

The superconducting cable is provided with a terminal connecting box at its end, and the connecting box is attached to a terminal conductor that is extended outward. The terminal conductor is connected to a core.

In the superconducting cable with such a structure, an inner metallic tube surrounds the core, and an outer metallic tube surrounds the inner metallic tube. The inner tube is filled with liquid nitrogen, and a vacuum state is formed between the inner and the outer metallic tubes as to maximize the insulation effect.

In this structure, the outer tube is in contact with the outside surroundings, and the inner tube is in contact with liquid nitrogen. So, the inner tube may shrink more than the outer tube does. But, because the ends of the inner and the outer tubes are connected to the connecting box, the inner tube may be affected by tensile force due to its shrinkage. The inner tube is under stress caused by the tensile force, and the superconducting cable may be distorted.

Moreover, the vacuum state between the inner and the outer metallic tubes is controlled under the same condition up to the terminal connecting box. Therefore, the whole vacuum state would be broken when the terminal connecting box or the superconducting cable is under maintenance.

### SUMMARY

As a solution to the problems described above, a cryostat of a superconducting cable according to the embodiment herein is to compensate the stress caused by the difference in temperature, and to separate vacuum spaces between the superconducting cable and a terminal connecting box so that one of the spaces remains in a vacuum even when the vacuum state of the other space is eliminated.

Disclosed herein is a cryostat of a superconducting cable which includes an inner metallic tube filled with liquid nitrogen and extending along the circumference of a core, an outer metallic tube surrounding the circumference of the inner metallic tube at a distance, a cooling vessel of a terminal connecting box connected to the inner metallic tube and filled with liquid nitrogen, an insulation tube surrounding the circumference of the cooling vessel at a distance, an inner bellows tube connecting an end of the outer metallic tube to the cooling vessel, and an outer bellows tube spaced apart from the inner bellows tube and connecting the end of the outer metallic tube to the insulation tube. The space between the inner and the outer bellows tubes is separated from the space between the inner bellows tube and the inner metallic tube.

Further, in one aspect, the space between the inner and the outer bellows tubes and the space between the inner bellows tube and the inner metallic tube may be in a vacuum.

In another aspect, the inner and the outer metallic tubes may be made of a material having a higher thermal shrinkage rate than that of the core.

In another aspect, the inner and the outer metallic tubes may be made of aluminum.

As explained above, the cryostat of the superconducting cable according to the embodiment herein may compensate for the stress occurring due to thermal shrinkage with bellows tubes formed in the inner and outer metallic tubes, which are made of a material having a higher thermal shrinkage rate than that of the core. Therefore, the metallic tubes would not be under stress due to thermal shrinkage, and thus may not be distorted.

Further, the cryostat of the superconducting cable according to the embodiment separates the vacuum state of the superconducting cable side from that of the terminal connecting box side, so that one side remains in a vacuum even when the vacuum state of the other side is eliminated for maintenance or repairs.

Moreover, the cryostat of the superconducting cable according to the embodiment has the inner and outer bellows tubes mounted in the cable so as to increase the paths through which heat flows in and to minimize the heat loss and compensate for thermal stress. The bellows tubes and the outer metallic tube are linked to each other so as to expand or contract.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 generally illustrates a superconducting cable mounted to a terminal connecting box according to the embodiment described herein; and

FIG. 2 is a sectional view illustrating a part of the bellows depicted in FIG. 1.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

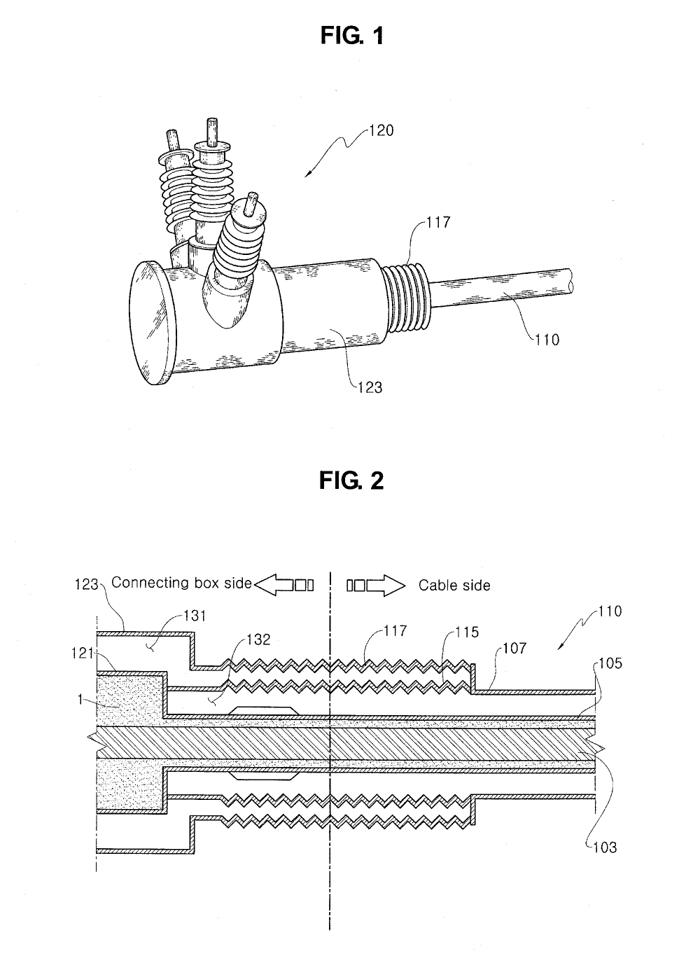

FIG. 1 generally illustrates a superconducting cable mounted to a terminal connecting box according to the embodiment described herein. FIG. 2 is a sectional view illustrating a part of the bellows depicted in FIG. 1.

As shown in FIGS. 1 and 2, the superconducting cable 110 is connected to the terminal connecting box 120.

The terminal connecting box 120 comprises a cooling vessel 121 connected to an inner metallic tube 105 of the cable 110, and an insulating tube 123 surrounding the outer surface of the cooling vessel 121 at a distance. A core 103 of the cable 110 is inserted into the cooling vessel 121 along the inner metallic tube 105 in order to be connected to a terminal conductor. Herein, the cooling vessel 0121 is the inner component of a cryostat of the terminal connecting box 120, and the insulating tube 123 is the outer component of the cryostat of the box 120.

Further, an outer metallic tube 107 of the cable 110 is extended to the connecting box 120 along the cable 110, and an outer bellows tube 117 and an inner bellows tube 115 are connected to an end of the outer metallic tube 107.

The outer bellows tube 117 is connected to the insulating tube 123, and the inner bellows tube 115 is connected to the outside of the vessel 121.

In this structure, the interior of the vessel 121 and the inner metallic tube 105, which enclose the core 103, are filled with liquid nitrogen 1. The space between the inner and the outer bellows tubes 115 and 117 is communicated with the space between the cooling vessel 121 and the insulating tube 123, which is referred to as a first vacuum space 131. The space between the outer and the inner metallic tubes 107 and 105 is communicated with the space between the inner bellows tube 115 and the outer metallic tube 107, which is referred to as a second vacuum space 132.

As such, the first vacuum space 131 is separated from the second vacuum space 132 by the inner bellows tube 115. Therefore, even when one of the spaces is released from the vacuum state, the other may remain in a vacuum.

Therefore, when the vacuum state in the side of the terminal connecting box 120 or the side of the superconducting cable 110 is eliminated for maintenance or repairs, the other side may remain in vacuum state. This leads to an easier operation for forming vacuum state again after the maintenance or repair is finished.

The shrinkage under very low temperatures is explained hereafter.

The inner metallic tube 105 and the outer metallic tube 107, according to the embodiment, are made of a material having a higher thermal shrinkage rate than that of the core 103. If the core 103 is made of copper, the inner and the outer metallic tubes 105 and 107 may be made of aluminum.

The selection is determined considering the thermal shrinkage rates of materials. The thermal shrinkage rate is higher in the order of stainless steel, copper, and aluminum. In other words, as the temperature becomes lower, aluminum is the most, stainless steel is the least, and copper is between the two in the degree of the shrinkage rate, among the three.

Although the existing inner and the outer metallic tubes are made of stainless steel, the tubes 105 and 107 according to the embodiment are made of aluminum.

Therefore, in the cryostat of the superconducting cable 110 according to the embodiment, the inner metallic tube 105 and the core 103 are in contact with liquid nitrogen 1, and the outer metallic tube 107 is at normal temperature. In such a structure, the variation in temperature causes stress in the inner and the outer metallic tubes 105 and 107 due to the shrinkage, and the inner and the outer bellows tubes 115 and 117 may expand or contract to offset the stress. As a result, the superconducting cable may not be deformed.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1-4. (canceled)

5. A cryostat of a superconducting cable comprising:
an inner metallic tube filled with liquid nitrogen and extended along the circumference of a core;
an outer metallic tube surrounding the circumference of the inner metallic tube at a distance;
an inner bellows tube extending from an end of the outer metallic tube and connected to the inner part of a terminal connecting box which is kept at low temperature; and
an outer bellows tube extending from the end of the outer metallic tube and connected, at a distance, to the outer part of the connecting box which is kept at low temperature;
wherein a space between the inner bellows tube and the outer bellows tube is separated from a space between the inner bellows tube and the inner metallic tube.

6. The cryostat of the superconducting cable according to claim 5, wherein the space between the inner bellows tube and the outer bellows tube and the space between the inner bellows tube and the inner metallic tube are evacuated.

7. The cryostat of the superconducting cable according to claim 5, wherein the inner metallic tube and the outer metallic tube are made of a material having a higher thermal shrinkage rate than that of the core.

8. The cryostat of the superconducting cable according to claim 7, wherein the inner metallic tube and the outer metallic tube are made of aluminum.
